(19) United States
(12) Patent Application Publication
(10) Pub. No.: US 2024/0242268 A1
(43) Pub. Date: Jul. 18, 2024

(54) METHOD AND SYSTEM FOR ANONYMOUS NEGOTIATIONS BETWEEN PARTIES

(71) Applicant: Meraglim Holdings, West Palm Beach, FL (US)

(72) Inventor: John T. Rickard, Larkspur, CO (US)

(21) Appl. No.: 18/098,101

(22) Filed: Jan. 17, 2023

(51) Int. Cl. G06Q 30/08; G06Q 30/0601

(52) U.S. Cl. CPC G06Q 30/08; G06Q 30/0643

(57) ABSTRACT

The present invention is for calculating the relationships between transaction values, comprising: program instructions to extract a set of user's preferences and priorities related to at least one asset; program instructions to score at least one attribute, wherein the at least one attribute is pertaining to the at least one asset using an analytic hierarchy process; program instructions to generate a graphical representation of the attributes of the at least one asset in a user interface, wherein a mutually acceptable transaction area is identified within at least two feasibility regions, and the transaction area is identified based on proximity to the user's preferences and priorities; and program instructions to process a transaction between a user and one or more contra parties.

### BACKGROUND

The present invention relates generally to methods for performing negotiations between parties and more particularly to a method for performing a negotiation between multiple parties without disclosing the identity and attribute preferences of the parties to each other while also taking into account various external factors to assist in facilitating the transaction. The present invention also relates generally to methods and apparatuses for performing computerized trading.

In negotiations, parties often desire to negotiate a transaction involving something of value to both parties or multiple parties, but are wary of disclosing their willingness to deal on any attribute of the deal for fear of losing negotiating strength. In fact, it is a well-known negotiating tactic to avoid being the first party to suggest an offer, since that sets the stage for the remaining offers. The analogous situation applies to being the first party to suggest a bid. However, it is practically impossible to negotiate without a starting point.

Traditional markets are distributive, in the sense that any adjustment of the transaction terms (e.g., price) redounds to the benefit of one party, at the expense of the contra party. An integrative market structure is one that enables the discovery of adjustments to transaction terms that are perceived as a benefit by both sides. Negotiation among market participants, as a part of the process leading up to a transaction, allows for integrative markets. This process may involve multiple stages of preliminary matching before a transaction is consummated. Information sharing prior to and during these stages is essential to facilitate negotiation. Many B2B markets will require this capability.

### SUMMARY

In a first embodiment, the present invention is a computer-implemented method for calculating the relationships between concepts, comprising: extracting, by at least one processor, a set of user's preferences and priorities related to at least one asset; scoring, by the at least one processor, at least one attribute, wherein the attribute is pertaining to the at least one asset; generating, by the at least one processor, a graphical representation of the attributes of the at least one asset in a user interface, wherein mutually acceptable transaction area is identified within at least two feasibility regions; and processing, by the at least one processor, a transaction between a user and a contra party.

In a second embodiment, the present invention is a computer program product for calculating the relationships between concepts, comprising: one or more computer non-transitory readable storage media and program instructions stored on the one or more computer non-transitory readable storage media, the program instructions comprising: program instructions to extract a set of user's preferences and priorities related to at least one asset; program instructions to score at least one attribute, wherein the at least one attribute is pertaining to the at least one asset using an analytic hierarchy process; program instructions to generate a graphical representation of the attributes of the at least one asset in a user interface, wherein a mutually acceptable transaction area is identified within at least two feasibility regions, and the transaction area is identified based on proximity to the user's preferences and priorities; and program instructions to process a transaction between a user and a contra party.

In a third embodiment, the present invention is a system for calculating the relationships between concepts, comprising: one or more computer non-transitory readable storage media and program instructions stored on the one or more computer non-transitory readable storage media, the program instructions comprising: extract a set of user's preferences and priorities related to at least one asset; score at least one attribute, wherein the attribute is pertaining to the at least one asset; performing a stepwise negotiation process based on the user's preferences and priorities and a contra party's preferences and priorities; generate a graphical representation of the attributes of the at least one asset in a user interface, wherein a mutually acceptable transaction area is identified within at least two feasibility regions; and process a transaction between a user and a contra party.

### BRIEF DESCRIPTION OF THE DRAWINGS

Referring now to the drawings in which like reference numbers represent corresponding parts throughout:

FIG. 1 depicts a representative computer system/server node implementation, according to an embodiment of the present invention.

FIG. 2 depicts a cloud computing environment, according to an embodiment of the present invention.

FIG. 3 depicts abstraction model layers, according to an embodiment of the present invention.

FIG. 4 depicts a block diagram depicting a computing environment, according to an embodiment of the present invention.

FIG. 5 depicts a flowchart showing the process of connecting the buyer and seller, according to an embodiment of the present invention.

FIG. 6 depicts illustrations of attribute distributions, viewpoints and preferences, in accordance with an embodiment of the present invention.

FIG. 7 depicts an illustration of an analytical hierarchy for car buying, in accordance with an embodiment of the present invention.

FIG. 8 depicts an illustration of a profile exhibiting preferential dependence between two attributes, in accordance with an embodiment of the present invention.

FIG. 9 depicts an illustration of negotiation process converging to a transaction point, in accordance with an embodiment of the present invention.

FIG. 10 depicts an illustration of hyperbox combinations and covering hyperboxes in two dimensions, in accordance with an embodiment of the present invention.

FIG. 11 depicts an illustration of a two-dimensional example of hyperbox geometry, in accordance with an embodiment of the present invention.

FIG. 12 depicts an illustration of compromise and consideration vector components, in accordance with an embodiment of the present invention.

FIG. 13 depicts an illustration of relative weight functions for compromise and consideration vector components, in accordance with an embodiment of the present invention.

### DETAILED DESCRIPTION

The present invention is described below in the context of trading commodities and other tangible assets. However, the invention is not so limited and can be easily adapted to allow the trading of any assets. It can be adapted to the trading of tangible and non-tangible assets as well as financial assets having multiple attributes of interest in addition to price and quantity. For example, various attributes involving quality, availability, delivery costs, etc. may be included in the negotiations between buyers and sellers.

Intended users of the representative embodiments of this invention are typically investors, traders, buyers, sellers, brokers or others who deal in or trade commodities and other tangible or non-tangible assets. As used herein, the term “user”, “trader”, “buyer”, “seller” or “investor” means that person or entity who wishes to make a transaction.

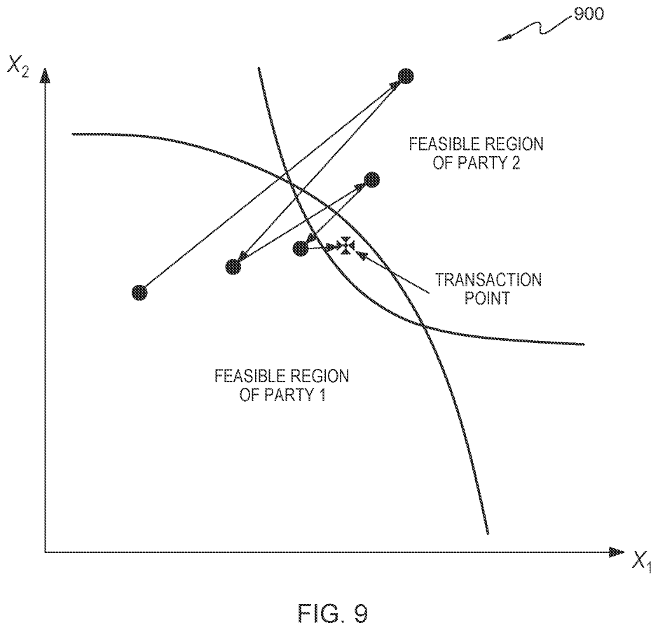

A system that goes beyond price and quantity as the basic decision variables for transacting must provide a means for users to express their preferences for various attribute values in some quantitative fashion, and to rank quantitatively the relative importance of these attributes. An essential characteristic of preferential dependence is that one's preference for a given attribute depends explicitly upon other attribute values. For the case of two attributes, the present invention provides a convenient visual means of describing this preferential dependence in detail, using color to indicate the preference values over a two-dimensional grid representing values of the attributes. In principle, one can extend this color-coding scheme to the case of three attributes, but it becomes virtually impossible to create a visual representation of preferences as the number of attribute dimensions increases. The alternative is to express a stepwise preferential independence at any particular stage of negotiation, and then allow the sequential steps of negotiation to account for the preferential dependencies. This is embodied in the offer/counteroffer strategy commonly used in manual negotiations, where the multiple adjustments to terms made at successive stages of negotiation effectively trace out feasible paths through the actual preferential dependencies of each party in the dimensions of the transaction space. A simple illustration for two preferentially dependent attributes is shown in FIG. 9, which shows the path of a hypothetical sequence of offers and counteroffers (represented by the dots connected by arrows) leading to a transaction point in the region of overlap of the parties' preference functions.

Negotiations thus involve a sequential search for a transaction point, as opposed to an effectively parallel search simultaneously across all attribute dimensions. The latter requires an ability explicitly to express the preference function in its full dimensionality, whereas the former does not. Instead, the preference function is implicit in the offers/counteroffers made by the respective parties. By comparison, a preference profile would require a buyer or seller to formulate a priori the set of all feasible trades they are willing to accept, along with their corresponding preference values, and then perform a parallel search for a match. In the absence of disclosure of, or the inability to express, the party's full preference functions, the above negotiation strategy may enhance search efficiency by providing each party at a given stage of negotiation a history of feedback from the contra party that better enables them to formulate the next offer. However, it is important to note that the efficiency of this serial search depends upon having reasonable starting points for both parties that will enable them to converge in a feasible number of steps to a mutually acceptable transaction point. If their starting points are too disparate, a lot of time and effort may be expended in maneuvering offers/counteroffers without converging on a mutually acceptable solution, if one exists.

Thus, the present invention is advantageous because it enables the negotiation process convergence to provide a beneficial transaction for both the buyer and the seller, while also providing real time data so that, as the asset attribute values adjust, the transaction remains beneficial for all parties. Additionally, given that in a typical sale of an asset, transportation of said asset is required, the present invention can incorporate the shipping/transportation costs into the price to create an accurate and honest price for the buyer and seller. The present invention can be used in a variety of market structures such as auction markets, reverse auction markets, and exchanges.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

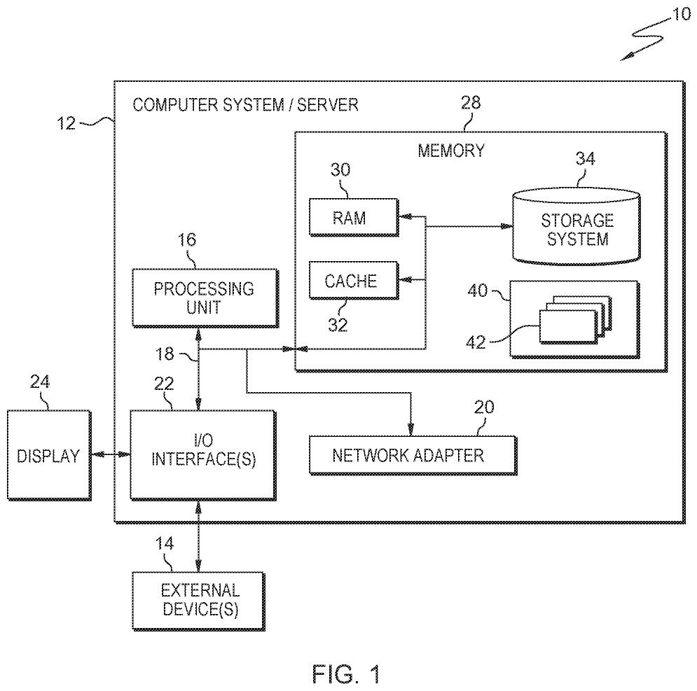

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

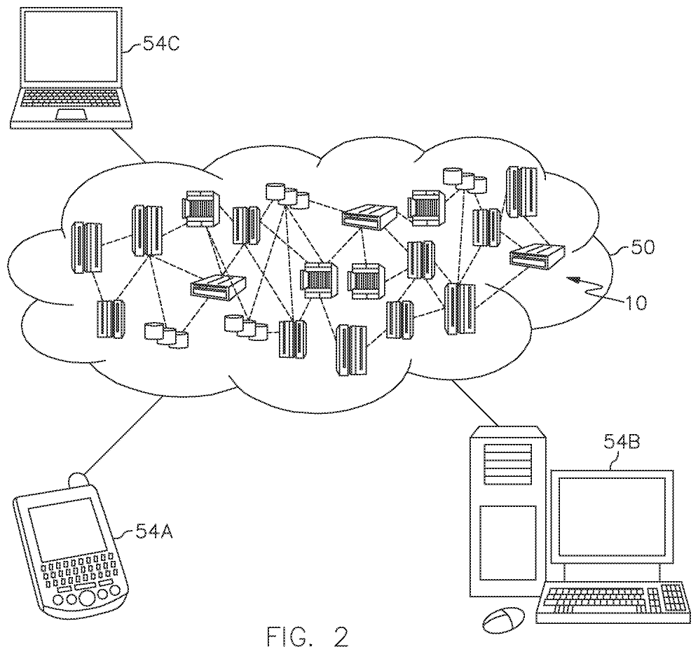

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

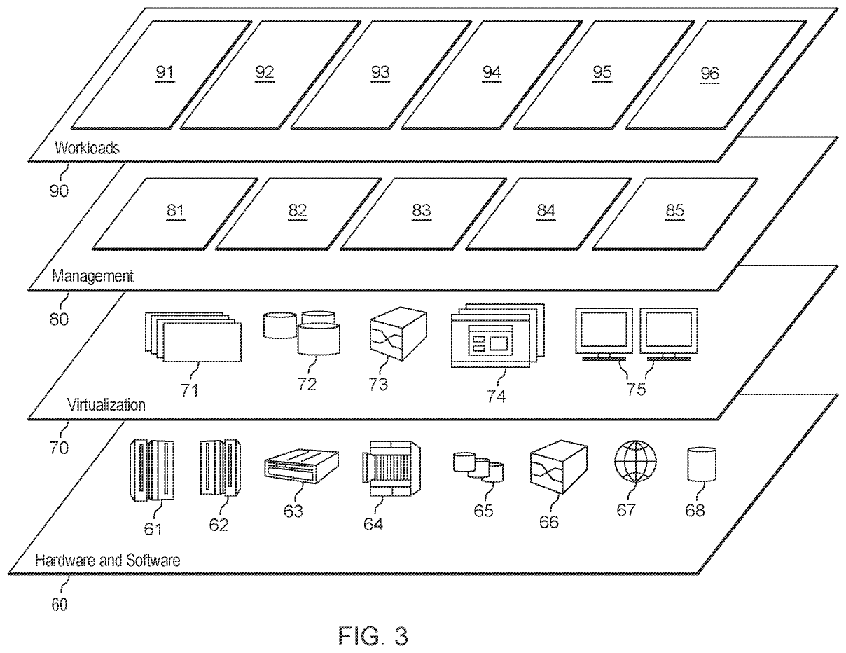

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and parking space selection 96.

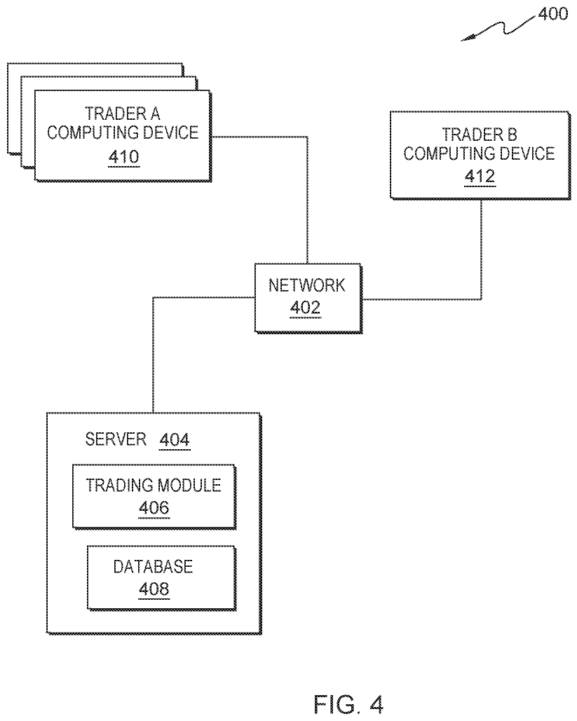

FIG. 4 depicts a block diagram of a computing environment 400 in accordance with one embodiment of the present invention. FIG. 1 provides an illustration of one embodiment and does not imply any limitations regarding the environment in which different embodiments maybe implemented.

FIG. 4 depicts a block diagram of a computing environment 400 in accordance with one embodiment of the present invention. FIG. 4 provides an illustration of one embodiment and does not imply any limitations regarding the environment in which different embodiments maybe implemented. In the depicted embodiment, computing environment 400 includes network 402, server 404, trader A computing device 410, and trader B computing device 412. Computing environment 400 may include additional servers, computers, or other devices not shown.

Network 402 may be a local area network (LAN), a wide area network (WAN) such as the Internet, any combination thereof, or any combination of connections and protocols that can support communications between server 404, trader A computing device 410 and trader B computing device 412 in accordance with embodiments of the invention. Network 402 may include wired, wireless, or fiber optic connections. The network 402 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 402 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 402 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

Trader A computing device 410 comprise one or more computing devices which can receive input from an information source and transmit and receive data via network 402. The trader A computing device 410 may be any other electronic device or computing system capable of processing program instructions and receiving and sending data. In one embodiment, the trader A computing device 410 is a conventional computer system executing, for example, a Microsoft Windows compatible operating system (OS), Apple OS X, and/or a Linux distribution. In another embodiment, the trader A computing device 410 can be a device having computer functionality, such as a smart-phone, a tablet, a personal digital assistant (PDA), a mobile telephone, etc. In some embodiments, trader A computing device 410 may be a laptop computer, tablet computer, netbook computer, personal computer (PC), a desktop computer, or any programmable electronic device capable of communicating with server 404 and trader A computing device 410 via network 402. In other embodiments, the trader A computing device 410 may represent a server computing system utilizing multiple computers as a server system, such as in a cloud computing environment. In another embodiment, the trader A computing device 410 represents a computing system utilizing clustered computers and components to act as a single pool of seamless resources. Trader A computing device 410 may be a single trader or a plurality of traders.

Trader B computing device(s) 412 comprise one or more computing devices which can receive input from a user and transmit and receive data via network 402. The Trader B computing device 412 may be any other electronic device or computing system capable of processing program instructions and receiving and sending data. In one embodiment, the Trader B computing device 412 is a conventional computer system executing, for example, a Microsoft Windows compatible operating system (OS), Apple OS X, and/or a Linux distribution. In another embodiment, the Trader B computing device 412 can be a device having computer functionality, such as a smart-phone, a tablet, a personal digital assistant (PDA), a mobile telephone, etc. In some embodiments, client computing device 412 may be a laptop computer, tablet computer, netbook computer, personal computer (PC), a desktop computer, or any programmable electronic device capable of communicating with server 404 and trader B computing device 412 via network 402. In other embodiments, the Trader B computing device 412 may represent a server computing system utilizing multiple computers as a server system, such as in a cloud computing environment. In another embodiment, the Trader B computing device 412 represents a computing system utilizing clustered computers and components to act as a single pool of seamless resources. Trader B computing device 410 may be a single trader or a plurality of traders.

Server 404 may be a management server, a web server, or any other electronic device or computing system capable of processing program instructions and receiving and sending data. In another embodiments server 404 may be a laptop computer, tablet computer, netbook computer, personal computer (PC), a desktop computer, or any programmable electronic device capable of communicating via network 402. In one embodiment, server 404 may be a server computing system utilizing multiple computers as a server system, such as in a cloud computing environment. In one embodiment, server 404 represents a computing system utilizing clustered computers and components to act as a single pool of seamless resources. In the depicted embodiment trading module 406 and database 408 are located on server 404.

Trading module 406 functions to connect Trader A and Trader B based on both the requests of each trader. With regards to commodity trading, Trader(s) A may have commodity which they are willing to sell and Trader(s) B has an interest in buying the commodity. The trading module 406, based on the trader's supply and demand are able to connect, anonymously the traders to complete the transaction, while also providing both the buyer and seller an ideal relationship based on the trader's preferences and requests (e.g. price, quantity, deliver time line, delivery location, delivery method, etc.). In the depicted embodiment, the trading module 406 resides on server 404. In other embodiments, the trading module 406 may be located on another server, computing device, or exist in a cloud computing system, provided the trading module 406 has access to trader A computing device 410 and trader B computing device 412, or an SME within the network 102.

Database 408 may be a repository that may be written to and/or read by Trader A and B computing devices 410 and 412 as well as trading module 406. Data related to the trader A and data related to the Trader B, all or portions of the sources, as well as other data generated by the trading module 406 may be stored in database 408. In one embodiment, database 408 is a database management system (DBMS) used to allow the definition, creation, querying, update, and administration of a database(s). In the depicted embodiment, database 408 resides within server 404. In other embodiments, database 408 resides on another server, or another computing device, provided that database 408 is accessible by trading module 406 and Trader A computing device 410 and their components.

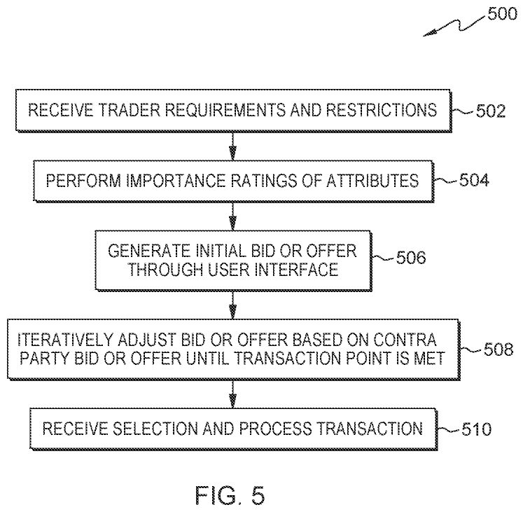

FIG. 5 depicts a flowchart of the operational steps 500 taken by the trading module 406 to provide the transaction point(s) for the user based on their requirements and the contra party's(s) offer, in accordance with an embodiment of the present invention. FIG. 5 provides an illustration of one embodiment and does not imply any limitations regarding a computing environment in which different embodiments may be implemented. Many modifications to the depicted flowchart may be made.

The present method provides for the connection between a buyer(s) and a seller(s) to process the transaction of a commodity. The method provides for an anonymous transaction process for a seller to sell a large quantity of a commodity to a number of buyers, or for a buyer to locate a commodity from a number of sellers, while including in the transaction price the transportation costs, while also taking into account the market conditions and the buyer(s)' conditions for the sale. This method is advantageous to allow for a dynamic sale of a commodity at a price point that is both beneficial and accurate given the market and transportation conditions.

In step 502, the trading module 406 receives the traders' requirements and restrictions. The trader who is either a buyer or seller of the asset is able to input the data which is related to their desired position in the transaction. For example, a trader who is looking to buy an asset may input the desired commodity they wish to purchase, the quantity, multiple desired quality attributes of the commodity, the delivery date(s), the delivery method(s), the number of potential sellers, delivery location(s), etc. The trading module 406 also takes into account the trader's profile and historic performance using the system. A trader who is looking to sell a commodity is able to input their commodity details (e.g. quality and the like), quantity, quantity minimum buys, quantity maximum buys, location, delivery methods available, delivery date(s) available, price per unit of the commodity, and the like. The trader who is looking to sell, has their account analyzed to determine past performance and the like. In some instances, the prices of the commodity are controlled or determined by outside sources (e.g. exchanges and market pricing) and these values are collected by the trading module 406 having access to this information and the sources.

In one embodiment, point attribute values are used. The simplest form of attribute scoring corresponds to the case where an attribute has a single value (which can be continuous, discrete or Boolean), and the user or program specifies a scalar preference function mapping attribute values to preference values lying between zero and unity. The simplicity of this approach depends upon the ease (and confidence) with which the user or the program can express or evoke this absolute preference as a function of attribute values. Where this is feasible, the preference scoring is straightforward.

In another embodiment, the attribute may have a distribution of values corresponding to a given alternative. For example, in a market for bags of cut diamonds, a given bag will contain diamonds with distributions of color, cut, clarity and carat weight values. Furthermore, suppose that users have attribute preference viewpoints regarding different attribute values. For example, one buyer may prefer a bag that contains mostly stones of weight less than 0.1 carats, but also would like a few stones in the range of 0.3 to 0.4 carats. Another buyer may prefer a bag with stones confined primarily to the range of 0.2 to 0.3 carats. Problems of this sort can be addressed by calculating the functional inner product of the attribute distribution with the user viewpoint, which is described below.

Given two non-negative functions μ_{A}(x) and μ_{B}(x), their normalized functional inner product is defined as follows:

$$S ( A , B ) = \frac{{\int }_{- ∞}^{∞} {μ}_{A} ( x ) {μ}_{B} ( x ) dx}{\sqrt{{\int }_{- ∞}^{∞} {{μ}_{A} ( x )}^{2} d x {\int }_{- ∞}^{∞} {{μ}_{B} ( y )}^{2} dy}} .$$

S(A,B) can be viewed in a fuzzy sense as the degree to which the function μ_{A}(x) is a scaled multiple of μ_{B}(x), since 0≤S(A,B)≤1, and S(A,B)=0 when μ_{A}(x) is functionally orthogonal to μ_{B}(x), while S(A,B)=1 when μ_{A}(x) is a scaled multiple of μ_{B}(x).

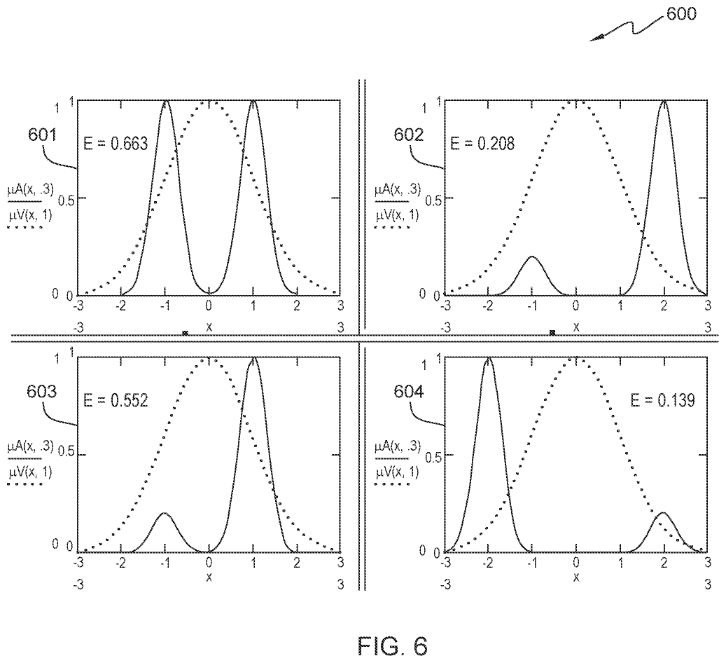

One can consider the distribution of attribute values for a given alternative as fuzzy membership functions in the corresponding attribute as shown in FIG. 6. Let μ_{A}(x) be a membership function of the fuzzy number A. In the example above, μ_{A}(x) might represent the distribution of carat weights for a given bag of diamonds. A market participant can describe their preferences for attribute values in terms of another fuzzy set denoted as a viewpoint V, with membership function μ_{V}(x). A valid viewpoint membership function must span the support interval of μ_{A}(x) and must be integrable with non-zero integral. The viewpoint defines a preference structure on values of the attribute.

The preference of A in the viewpoint V is defined by

$${E}_{V} ( A ) = S ( A , V )$$

E_{V}(A) represents the degree to which the distribution of attribute values characterized by A corresponds to preferred values as expressed by the viewpoint. Note that E_{V}(A) is a number between 0 and 1, with a value of 1 indicating perfect correspondence of the distribution of attributes A with the viewpoint preferences V. FIG. 6 illustrates a number of examples of attribute distributions depicted in graphs 601, 602, 603, and 604 with a common viewpoint, and the corresponding preference values.

The evaluation values E_{V}(A) provide a natural measure for the absolute scaling and ranking of alternatives involving distributions of attribute values using, for example, the Analytic Hierarchy Process (AHP).

The AHP is a method of decision making that is derived fundamentally from pairwise comparisons of relative priorities between candidate evaluation criteria (e.g., attributes). These are ordered in a hierarchy, with the decision itself at the top of the hierarchy, below which are criteria and sub-criteria in as many levels as desired, culminating in the candidate alternatives at the bottom level of the hierarchy.

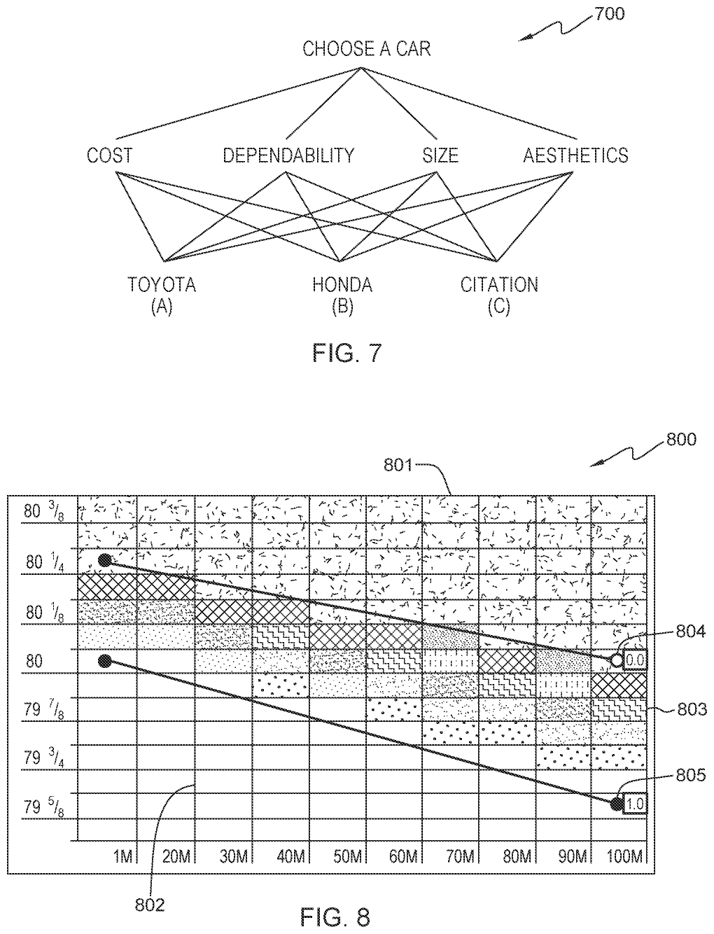

A simple example of such a decision hierarchy for deciding upon a car purchase is shown in FIG. 7. This example 700 has only one level of criteria, i.e., cost, dependability, size and aesthetics, and three alternatives; Toyota, Honda, and Citation.

Assume a perfectly consistent set of normalized importance weights w₁, . . . wₙ among a set of decision alternatives or decision criteria. By “perfectly consistent”, we mean that the weights satisfy the transitive property such that, if alternative or criterion #1 is twice as important as #2, and if #2 is twice as important as #3, then #1 is four times as important as #3. By “normalized” mean that the weights sum to unity. If the square matrix is formed from the pair wise weight ratios and post-multiplied by the weight vector, the following is obtained:

$$[ \begin{matrix}{w}_{1} / {w}_{1} & {w}_{1} / {w}_{2} & … & {w}_{1} / {w}_{n} \\ {w}_{2} / {w}_{1} & {w}_{2} / {w}_{2} & … & {w}_{2} / {w}_{n} \\ ⋮ & ⋮ & … & ⋮ \\ {w}_{n} / {w}_{1} & {w}_{n} / {w}_{2} & … & {w}_{n} / {w}_{n}\end{matrix} ] [ \begin{matrix}{w}_{1} \\ {w}_{2} \\ ⋮ \\ {w}_{n}\end{matrix} ] = n [ \begin{matrix}{w}_{1} \\ {w}_{2} \\ ⋮ \\ {w}_{n}\end{matrix} ]$$

The above weight ratio matrix is a reciprocal matrix, whose diagonal elements are all unity, and whose transpose elements are reciprocals. Furthermore, every row of the matrix is a scalar multiple of the first row, so the matrix has only one non-zero eigenvalue, which by observation is equal to n, with corresponding eigenvector equal to the weight vector itself.

As opposed to this example, typically there is not a perfectly consistent set of importance weights, but rather an estimate of such a set. The above identity suggests a means of doing this, by estimating pairwise ratios of relative importance among pairs of alternatives and/or criteria. This is equivalent to estimating the set of upper triangular entries in the matrix and filling in the remainder of the matrix with ‘1’s on the diagonal and the transpose reciprocal elements in the lower triangular entries.

The resulting matrix A generally will not be perfectly consistent (i.e., its elements may not satisfy the transitive property), but nevertheless we can solve for its largest (i.e., principal) eigenvalue and corresponding eigenvector, analogous to the above approach. Given certain known perturbation properties of matrices and their eigenvalues/eigenvectors, it can be assured that small errors in consistency among the matrix elements aᵢⱼ will produce small perturbations of the eigenvalues and corresponding eigenvectors from those that would be obtained with perfect consistency. Therefore, providing reasonably consistent estimates of the importance ratios aᵢⱼ, the largest eigenvalue of the A matrix will be close to (actually greater than or equal to) n, and the corresponding normalized eigenvector will be close to a consistent set of weights that reflects the estimates of the ratios.

A substantial body of practical experience suggests that the ratios of importance or priority be estimated using the following scale:

TABLE 1

| Ratio of Relative Priority | Subjective Description |
|---|---|
| Between Alternatives | of Comparison |
| 1 | Equal priority |
| 3 | Moderate priority |
| 5 | Strong priority |
| 7 | Very strong priority |
| 9 | Absolutely dominant priority |

Thus, considering an alternative i to have strong priority over alternative j, then the corresponding entries in the matrix A will be:

$${a}_{ij} = 5$$

$${a}_{ji} = 1 / 5.$$

Intermediate values (i.e., 2, 4, 6, 8) can be used for finer quantization of this scale if desired and it will be apparent that fewer or additional degrees of priority may be used instead of those in Table 1.

As a final technicality, the consistency of an estimated priority ratio matrix is easily checked by calculating the following consistency index CI:

$$CI = \frac{{λ}_{max} - n}{n - 1}$$

where λₘₐₓ is the largest eigenvalue of the estimated priority ratio matrix A. Calculating a reference value CI′ from λₘₐₓ′, the average of the principal eigenvalues of a large ensemble of randomly generated reciprocal matrices (which would not be expected to demonstrate any pattern of consistency), we obtain the following values for CI′:

| n | 2 | 3 | 4 | 5 | 6 | 7 | 8 | 9 | 10 | 11 | 12 | 13 | 14 | 15 |
|---|---|---|---|---|---|---|---|---|---|---|---|---|---|---|
| CI′ | 0.00 | 0.52 | 0.89 | 1.11 | 1.25 | 1.35 | 1.40 | 1.45 | 1.49 | 1.51 | 1.54 | 1.56 | 1.57 | 1.58 |

Thus for a given value of n, we compute a consistency ratio CR defined as:

$$CR = \frac{CI}{{CI}^{′}} .$$

A value for CR of 0.1 or less indicates a reasonable level of consistency. If this level is exceeded, the user should revise their assignment of pair wise priorities to obtain a more consistent set of priorities.

Inconsistencies in the estimated priority ratio matrix A can be identified by comparing its elements aᵢⱼ with the corresponding ratios of the magnitudes of the principal eigenvector elements |wᵢ|/|wⱼ| (bearing in mind that the wᵢ, i>1 may be complex numbers). If A were perfectly consistent, these ratios would be identical, since then A would have the form of a true reciprocal matrix. In other cases, we can write:

$${a}_{ij} = ( \frac{\vert \text{?} \vert}{\text{?}} ) ( 1 + {δ}_{ij} )$$

$$\text{?} \text{indicates text missing or illegible when filed}$$

where given δᵢⱼ, it is easy to show, from the reciprocal property of A, that

$${δ}_{ij} = \frac{- {δ}_{ji}}{1 + {δ}_{ji}} .$$

Thus since −1<δᵢⱼ≤0, then 0≤δⱼᵢ<∞, and vice versa, it follows that

$${η}_{i j} = min ( \vert {δ}_{i j} \vert , \vert {δ}_{j i} \vert ) = min ( \frac{\vert {w}_{j} \vert}{\vert {w}_{i} \vert} {a}_{i j} - 1 , \frac{\vert {w}_{i} \vert - \vert {w}_{j} \vert {a}_{i j}}{\vert {w}_{j} \vert {a}_{i j}} )$$

where

$$0 \leq {η}_{i j} < 1 ,$$

provides a scale of inconsistency, ranging between zero and unity, for the (i,j) element of A (and the corresponding reciprocal element). The elements aᵢⱼ with the largest values of ηᵢⱼ are the most inconsistent. By revising the pair wise priority assignments corresponding to these elements, and checking the value of CR at each step, the user can arrive at a reasonably consistent set of priorities.

Experience has shown that humans generally have difficulty making consistent assignments of priority between more than 7±2 alternatives. Thus, if a large number of criteria must be considered, it is best to decompose the criteria into hierarchical levels and perform the priority rankings on each level before aggregation. This also helps in maintaining the preferential independence of criteria that is essential in the use of weighted additive preference scoring. In the B2B space, this level of detail may only seldom be required, provided the number of criteria is small.

AHP pair wise comparisons can be used directly to rank alternatives with respect to the lowest level of criteria in a hierarchy, without having to make an absolute scale assignment of the sort contemplated. One simply uses the ratio scale of Table 1 or its analogous variations to construct, for each criterion, a reciprocal comparison matrix for the alternatives' relative satisfaction of that criterion, as described above. Upon calculating the normalized principal eigenvectors of each of these matrices, we obtain the relative rankings of the alternatives with respect to each criterion.

Note that this procedure results only in relative rankings among alternatives with respect to each attribute, not in an absolute degree of satisfaction of the attribute. In certain cases, the addition or deletion of another candidate alternative can result in the reversal of rankings of some alternatives. This can easily be remedied by including as one of the alternatives a hypothetical “perfect” candidate, in which case all the real alternatives are compared against this perfect candidate as well as against each other. The perfect candidate's score will of course be greater than or equal to that of any real candidate, and dividing it into the weights of the real candidates produces a set of absolute scores.

As an example of how the computations above are aggregated into a decision hierarchy, consider a case in which there are three candidate alternatives (designated A, B and C) compared against four criteria. Assume the buyer's reciprocal comparison matrices and their corresponding principal eigenvectors are as given below:

$$\begin{matrix} & Dependability & & Priority \\ & \begin{matrix}A & B & C\end{matrix} & & \\ \begin{matrix}A \\ B \\ C\end{matrix} & [ \begin{matrix}1 & 1 & 3 \\ 1 & 1 & 3 \\ 1 / 3 & 1 / 3 & 1\end{matrix} ] & \to & [ \begin{matrix}\text{.43} \\ \text{.43} \\ \text{.14}\end{matrix} ]\end{matrix}$$

$$\begin{matrix}Size & & Priority \\ \begin{matrix}A & B & C\end{matrix} & & \\ [ \begin{matrix}1 & 3 & 1 \\ 1 / 3 & 1 & 1 / 3 \\ 1 & 3 & 1\end{matrix} ] & \to & [ \begin{matrix}\text{.43} \\ \text{.14} \\ \text{.43}\end{matrix} ]\end{matrix}$$

$$\begin{matrix} & Aesthetics & & \\ & \begin{matrix}A & B & C\end{matrix} & & \\ \begin{matrix}A \\ B \\ C\end{matrix} & [ \begin{matrix}1 & 4 & 3 \\ 1 / 4 & 1 & 2 \\ 1 / 3 & 1 / 2 & 1\end{matrix} ] & \to & [ \begin{matrix}\text{.63} \\ \text{.22} \\ \text{.15}\end{matrix} ]\end{matrix}$$

$$\begin{matrix}Cost & & \\ \begin{matrix}A & B & C\end{matrix} & & \\ [ \begin{matrix}1 & 1 & 2 \\ 1 & 1 & 1 \\ 1 / 2 & 1 & 1\end{matrix} ] & \to & [ \begin{matrix}\text{.41} \\ \text{.33} \\ \text{.26}\end{matrix} ]\end{matrix}$$

Thus candidates A and B rank equally in dependability, and are roughly three times better than candidate C. Candidates A and C compare equally on size, and are three times better than candidate B, etc.

Now the buyer needs to rank the four criteria in order of importance, using the same procedure. In step 504, the pairwise importance ratings of the attributes are performed and the corresponding importance weights are calculated based on the attributes and the buyer's provided information related to these attributes. The program coordinates values for each attribute on both the buyer and seller side based on their respective rating of the attributes. Assume the reciprocal comparison matrix for this ranking, and thus the corresponding principal eigenvector is as follows:

$$\begin{matrix} & \begin{matrix}Cost & Depend . & Size & Aesth .\end{matrix} & & Priority & \\ \begin{matrix}Cost \\ Depend . \\ Size \\ Aesth .\end{matrix} & [ \begin{matrix}1 & 2 & 3 & 3 \\ 1 / 2 & 1 & 3 & 3 \\ 1 / 3 & 1 / 3 & 1 & 1 / 2 \\ 1 / 3 & 1 / 3 & 2 & 1\end{matrix} ] & \to & [ \begin{matrix}\text{.44} \\ \text{.31} \\ \text{.1} \\ \text{.15}\end{matrix} ] & \begin{matrix}Cost \\ Depend . \\ Size \\ Aesth .\end{matrix}\end{matrix}$$

The overall scores are then calculated by forming the composite matrix of candidate alternative scores for all criteria, and multiplying this matrix by the vector of criteria priority weights, resulting in the following vector of overall scores:

$$\begin{matrix} & \begin{matrix}Cost ( \text{.44} ) & Depend . ( \text{.31} ) & Size ( \text{.1} ) & Aesth . ( \text{.15} )\end{matrix} & & Overall Score \\ \begin{matrix}A \\ B \\ C\end{matrix} & [ \begin{matrix}\text{.41} & \text{.43} & \text{.43} & \text{.63} \\ \text{.33} & \text{.43} & \text{.14} & \text{.22} \\ \text{.26} & \text{.14} & \text{.43} & \text{.15}\end{matrix} ] & \to & [ \begin{matrix}\text{.45} \\ \text{.33} \\ \text{.22}\end{matrix} ]\end{matrix}$$

Thus alternative A scores the highest, followed by B, with C third.

Using the attribute scoring and prioritization methods above, and assuming preferential independence of the attributes, we can define a multi-dimensional, priority-weighted, additive preference function A(f₁(x₁), . . . f_{N}(x_{N})) for a given buyer or seller, where each xᵢ corresponds to an individual attribute (the latter may be continuous, discrete or Boolean variables), and fᵢ(xᵢ) represents the corresponding preference score for the value (or distribution of values) of xᵢ. N represents the total number of “standard” attributes involved in a transaction decision for a particular application domain.

The form of the preference function A(f₁(x₁), . . . f_{N}(x_{N})) is as follows:

$$A ( {f}_{1} ( {x}_{1} ) , … {f}_{N} ( {x}_{N} ) ) = {\sum }_{i = 1}^{N} {ω}_{i} {f}_{i} ( {x}_{i} ) ,$$

where ωᵢ represents the priority weight of the i^{th} lowest-level attribute propagated through the analytic hierarchy tree. Thus if the analytic hierarchy weights corresponding to the path of the i^{th} attribute through this tree are wᵢ₁, . . . w_{iL}, where L is the number of levels between the i^{th} attribute and the top of the tree, then

$${ω}_{i} = {\prod }_{j = 1}^{L} {w}_{i j} .$$

As an additive preference function, A(f₁(x₁), . . . f_{N}(x_{N})) is unable to incorporate the property of forcing the overall preference to zero if certain individual attribute preferences (or combinations thereof) fail to meet certain criteria. For example, if a preference score of zero in a particular attribute eliminates a candidate item from consideration, A(f₁(x₁), . . . f_{N}(x_{N})) generally will not be zero as a result of this one component having a zero value. Thus the overall preference function for a buyer/seller must take the form:

$$P ( {f}_{1} ( {x}_{1} ) , … {f}_{N} ( {x}_{N} ) ) = A ( {f}_{1} ( {x}_{1} ) , … {f}_{N} ( {x}_{N} ) ) B ( {f}_{1} ( {x}_{1} ) , … {f}_{N} ( {x}_{N} ) ) ,$$

where B(f₁(x₁), . . . f_{N}(x_{N})) is a Boolean function (i.e., with value of either zero or unity) of the individual attribute preferences that forces the overall preference to zero for unacceptable preference values of any particular attribute or combination of attributes.

In the most straightforward cases, the function B(f₁(x₁), . . . f_{N}(N)) will be used to define intervals (or points, in the case of discrete or Boolean attributes) of acceptable preference values, outside of which the overall preference is set to zero. For example, a single Boolean attribute that is a “must have” would result in a zero value for B(f₁(x₁), . . . f_{N}(x_{N})) should that attribute not be satisfied, and thus likewise for the overall preference function P(f₁(x₁), . . . f_{N}(x_{N})). It is important to recognize that going beyond this simple type of Boolean function to one that involves more complex combinations of attribute variables generally will result in preferential dependence among the attributes.

In many B2B applications, there may be a set of custom terms and conditions involved in a prospective transaction that are beyond the scope of the standard attributes. In one-to-many and many-to-many transactions, these might be lumped into a single Boolean variable x₀ that is included with the standard attribute variables, where agreement upon this set of terms and conditions equates to a ‘1’ value of this variable. The alternative is to include each term/condition as a separate attribute. In step 506, the initial bid of the buyer and seller is generated by the buyer or seller to enter the market and thereby allow a contra party to enter into a negotiation. In some embodiments, the program based on the user supplied information and the attribute ratings set is able to activate the entry into the market to allow the bidding process to begin, or is able to automatically start the bidding process based on known parties already active within the market. Through the user interface, the buyer and/or seller is able to initial the bidding process through their selection. This may be done through a manual action, or an automatic action once the attribute values have been set and a potential buyer or seller is identified. The potential buyer or seller may be identified based on a tolerance value ford each attribute, that provides the probability that an agreement could be met.

It is instructive to consider the negotiation problem in a geometric context. This not only helps in understanding the transaction process itself, but also guides us to an implementation approach for a negotiation engine by providing an indication of the “direction” in which the parties must move in order to close the gap for consummating a transaction.

Assume there are N attribute variables xᵢ, i=1, . . . N involved in a transaction decision. These variables define an N-dimensional space within which prospective transactions may occur. For continuous attribute variables, the attribute values in principle can take on any value in their corresponding dimension of this space, while for discrete or non-ordered (e.g., Boolean or color) variables they may take only point values.

In the following discussion, N is treated as a constant; however, this approach described implicitly supports a variable N. Allowing parties to introduce new attributes during the process of negotiation is one means of achieving integrative negotiations.

Associated with the attribute values in each dimension, there is an attribute preference score fᵢ(xᵢ), which can be either a function, which maps a single attribute value to a corresponding preference value, or a functional, which maps a distribution of attribute values to a corresponding preference value. These scores correspond to the evaluation method. The individual attribute preferences, along with any Boolean exclusions, are combined to define a feasible transaction region R in N-dimensional space for a buyer/seller, along with an overall preference function P(f₁(x₁), . . . f_{N}(x_{N})) defined over this region, where P(f₁(x₁), . . . f_{N}(x_{N})) is identically zero outside of R. Further denote the region of ‘1’ preference by R₁, where R₁⊆R. The desired objective is to find a point x in the feasible transaction regions of both the buyer(s) and seller(s) that maximizes their mutual preference to trade, ideally where x lies in the ‘1’ preference regions of both parties, if possible.

In the absence of an assumption of preferential independence, the feasible region R can take on arbitrarily complex geometric forms. A simple example of this is a scaled profile for price versus size, where the attributes are preferentially dependent, as illustrated in FIG. 8. In FIG. 8, illustration 800 shows region 801 and 802 where the prices are outside of a preferred range and region 803 where the prices are within the preferred range and are identified. Lines 804 and 805 are shown to highlight region 803 of the user's preferred price to size values. The graph shows each option in varying colors or textures to identify each region 801, 802, and 803, wherein region 803 has varying colors or textures to indicate a range of preferred values of the attributes of the assets based on the user's preferences to assist the user in selecting a price and size that would be most beneficial to the user.

The essential characteristic of preferential dependence is that one's preference for a given attribute depends explicitly upon other attribute values. For the case of two attributes, a two-dimensional profile provides a convenient visual means of describing this preferential dependence in great detail, using color to indicate the preference values over a two-dimensional grid representing values of the attributes. In principle, one can extend this color-coding scheme to the case of three attributes, but we then can only visualize preference values on slices through the three-dimensional volume of attribute space. Going beyond three dimensions, it is of course impossible to use this color visualization scheme.

Assuming preferential independence of the attributes, the feasible region R consists in general of one or more hyperboxes in N-dimensional space. (These are analogous to rectangles in 2-dimensional space, or rectangular boxes in 3-dimensional space.)

Given the difficulties of expressing, much less visualizing, multi-dimensional, preferentially dependent preference functions for more than two attributes, one might despair over the feasibility of such an approach to transaction decisions, since preferences generally do exhibit dependencies in real world applications. However, humans, without the benefit of analytics, routinely arrive at transaction decisions.

They do this by expressing a stepwise preferential independence at any particular stage of negotiation, and then allowing the sequential steps of negotiation to account for the preferential dependencies. This is embodied in the offer/counteroffer strategy commonly used in manual negotiations, where the multiple adjustments to terms made at successive stages of negotiation effectively trace out feasible paths through the actual preferential dependencies of each party in the N-dimensional transaction space. A simple illustration 900 for two preferentially dependent attributes is shown in FIG. 9, which shows the path of a hypothetical sequence of offers and counteroffers (represented by the dots connected by arrows) leading to a transaction point in the region of overlap of the parties' preference functions. This two-dimensional example can clearly be extended to an arbitrary number of dimensions.

In step 508, the program iteratively adjusts the bid and offer for each party based on the attribute rating and the current bid or offers for each attribute. This process continues until either a set of transaction values is met that both parties agree upon, or the process determines that no agreed upon transaction values can be met. The bids and counteroffers are adjusted based on the weighted transaction values for each attribute as determined in step 504.

Negotiations thus involve a sequential search for a transaction point, as opposed to the effectively parallel search that would require an ability explicitly to express the preference function, which the former does not. Instead, the preference function is implicit in the offers/counteroffers made by the respective parties. By comparison, a full preference profile approach requires that a buyer and seller formulate a priori the set of all feasible trades they are willing to accept, and then performs a parallel search for a match.

In the absence of disclosure of, or the inability to express, the party's full preference functions, the above negotiation strategy enhances search efficiency by providing each party at a given stage of negotiation a history of feedback from the contra party that better enables them to formulate the next offer. However, it is important to note that the efficiency of this serial search depends upon having reasonable starting points for both parties that will enable them to converge in a feasible number of steps to a mutually acceptable transaction point. If their starting points are too disparate, a lot of time and effort may be expended in maneuvering bids/counteroffers without converging on a mutually acceptable transaction, if one exists.

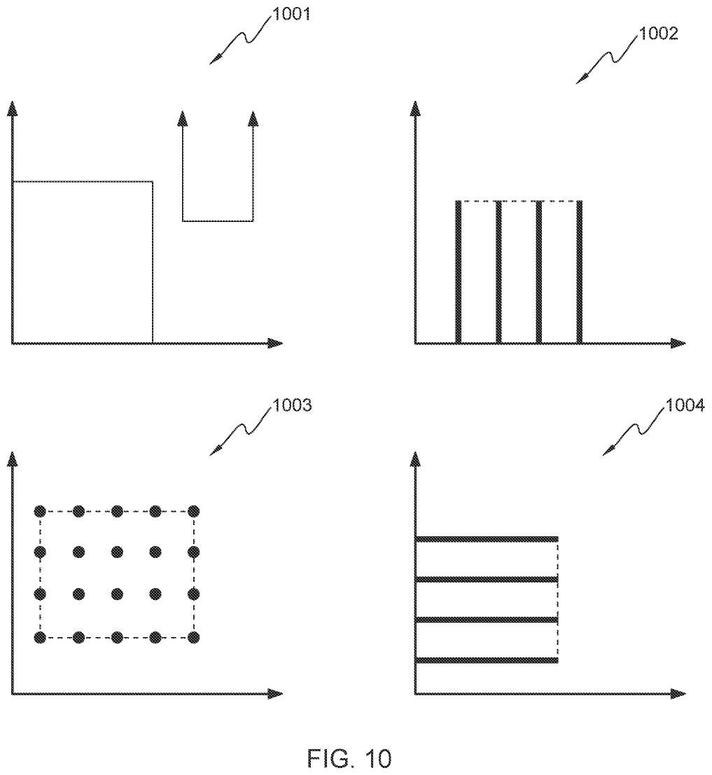

Depending upon the application, there may be only one, or many, hyperboxes representing a given offer/counteroffer point within the feasible region R. For continuous attribute, the boxes may have finite or infinite extent in the corresponding dimensions. Where attributes can take only discrete values, they will generate multiple hyperboxes (one for each acceptable attribute value), of one less dimension per box for each discrete attribute. At one extreme, where all attributes take on discrete values, the offer/counteroffer represents an N-dimensional lattice of points (each point being a 0-dimensional hyperbox). At the other extreme, where all attributes take on continuous values over single corresponding intervals, a single hyperbox of dimension N. In any event, the offer/counteroffer can always be enclosed within a single, N-dimensional “covering” hyperbox H that defines the boundaries of feasible attribute values, with a corresponding hyperbox Hₜ that covers the boundaries of attribute values with ‘1’ preference. For non-ordered attributes, there is no concept of “distance”, so these attribute types are not included in the geometric analysis to follow. FIG. 10 illustrates some of the possible combinations (assuming H and Hₜ coincide) in two dimensions as shown in illustrations 1001, 1002, 1003, and 1004.

Suppose that a buyer and seller who, at the i^{th} stage of negotiation, have presented bids and counteroffers in the form of preference functions P_{B,i}(f₁(x), . . . f_{N}(x_{N})) and P_{S,i}(fₜ(x₁), . . . f_{N}(x_{N})), respectively, defined over corresponding hyperbox feasible regions where the ‘1’ preference regions R_{B,i},R_{B1,i} and R_{B,i},R_{B1,i} and R_{S,i},R_{S1,i}, respectively, coincide.

Clearly, if the feasible regions for the buyer and seller intersect, then a transaction can be done at any point within the intersection region, preferably at a point that maximizes mutual preference. When the above regions do not overlap, providing directions to the party making the next bid/counteroffer that will help them potentially to converge to a transaction.

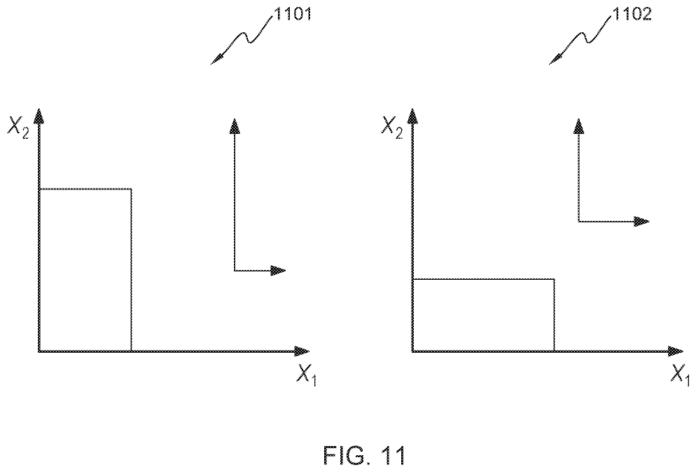

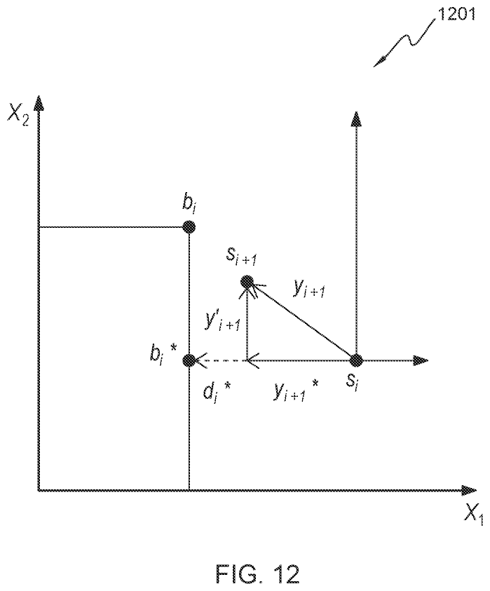

FIG. 11 depicts two no-overlap situations 1101 and 1102 between a buyer hyperbox region and a seller hyperbox region. In situation 1101, the buyer and seller are currently “in match” with regard to the value of the x₂ attribute they would be willing to transact, but they are not in match over the value of the x₁ attribute. In situation 1102, the buyer and seller are not in match over either attribute. In FIG. 12, situation 1201 is shown, which is identical to situation 1101 of FIG. 11. Suppose that it is the seller's move to present the next counteroffer.

Referring to FIG. 12, consider the vector \vec{d}ᵢ* from \vec{s}ᵢ, the corner of the seller's hyperbox, to \vec{b}ᵢ*, the nearest point on the buyer's hyperbox, which is given by

$${\vec{d}}_{i}^{*} = {\vec{b}}_{i}^{*} - {\vec{s}}_{i} .$$

The most direct path to convergence obviously would be a step along dᵢ*. However, the seller may elect to make a step \vec{y}ᵢ₊₁ that does not lie totally along this line.

As shown in FIG. 12, decomposing the seller's step \vec{y}ᵢ₊₁ into a vector component \vec{y}ᵢ₊₁* lying along \vec{d}ᵢ* and another vector component \vec{y}ᵢ₊₁′ orthogonal to \vec{d}ᵢ*. From vector algebra, these two components are given by

$${\vec{y}}_{i + 1}^{*} = ( \frac{{y}_{i + 1}^{T} {\vec{d}}_{i}^{*}}{{\vec{d}}_{i}^{* T} {\vec{d}}_{i}^{*}} ) {\vec{d}}_{i}^{*}$$

$${\vec{y}}_{i + 1}^{′} = {\vec{y}}_{i + 1} - ( \frac{{y}_{i + 1}^{T} {\vec{d}}_{i}^{*}}{{\vec{d}}_{i}^{* T} {\vec{d}}_{i}^{*}} ) {\vec{d}}_{i}^{*} .$$

The first component \vec{y}ᵢ₊₁* is denoted as the seller's compromise with the buyer on attributes not yet in match, while the second component \vec{y}ᵢ₊₁ is denoted as the seller's consideration for making this compromise.

The compromise vector components in any attribute dimension will always be in a direction of lower preference for the seller, while the consideration vector components will always be in a direction of higher preference. Otherwise, the seller would be increasing her distance from the buyer, and/or surrendering rather than receiving consideration on attributes that are already in match.

A convergent move is one for which the seller's new position vector sᵢ₊₁, given by

$${s}_{i + 1} = {s}_{i} + {y}_{i + 1} , \qquad ( 1 )$$

results in a smaller distance |\vec{d}*ᵢ₊₁| from the buyer than before, i.e.,

$$\vert {\vec{d}}_{i + 1}^{*} \vert < \vert {\vec{d}}_{i}^{*} \vert .$$

These distances can be measured by any p-norm (p≥1). Given the above geometric description, the seller's step can be further characterized in terms of the degree to which it closes this distance. Denoting the closure Dᵢ₊₁,

$${D}_{i + 1} = 1 - \frac{\vert {\vec{d}}_{i + 1}^{*} \vert}{\vert {\vec{d}}_{i}^{*} \vert} , 0 < {D}_{i + 1} \leq 1. \qquad ( 2 )$$

A value of zero for Dᵢ₊₁ implies that the seller is making no move to close the distance to the buyer. A value of unity (i.e., 100%) effectively “hits the bid”, i.e., intersects the buyer's current feasible region, while something less than unity leaves a gap, requiring the buyer to make a follow-on bid.

In higher dimensions, all of the above descriptions apply. The compromise vector lies along the line representing the shortest distance from the seller's hyperbox corner to the buyer's hyperbox, while the consideration vector lies in the hyperplane perpendicular to the compromise vector. The latter hyperplane is an (N−1)-dimensional subspace, so the consideration vector can lie anywhere within the intersection of the convergence region with this subspace.

The general approach to recommending the next move to the seller is to use the seller's ranking of attribute priorities as a guide to the seller's next move. For attributes that are not in match, presumably the seller would prefer to make proportionately smaller compromises for those attributes that are of higher priority, while allowing larger compromises for those attributes that are of lower priority. Conversely, for attributes that are in match, the seller would prefer to gain proportionately larger consideration for those attributes that are of higher priority, while asking for less consideration for those attributes that are of lower priority. This concept can be expanded in straightforward fashion to include both the seller's and the buyer's preferences in formulating this strategy, where appropriate.

To further clarify the above, let I_{A}(i) denote the index set of the attributes that are in match at the i^{th} stage of negotiation, I_{N}(i) denote the index set of attributes that are not in match, and denote I_{NC}(i) as the proper subset of I_{N}(i) representing the index set of attributes not in match for which the seller is not willing to make further compromise.

The priority weights ωⱼ for the attributes are computed from the analytic hierarchy weights and satisfy 0<ωⱼ<1.

Thus if:
j∈I_{A}(i), then the seller should seek increased consideration in the j^{th} attribute as ωⱼ increases,
j∈I_{N}(i)−I_{NC} (i) (i.e., the set of attributes not in match that can be further compromised), the seller should offer decreasing compromise in the j^{th} attribute as ωⱼ increases.

Since

$${\sum }_{j = 1}^{N} {ω}_{j} = 1 ,$$

the average value of the ωᵢ is always 1/N regardless of the distribution of priorities among the ωⱼ. If all attributes have the same priority weight of 1/N, then the same relative weight should be applied to all compromise or consideration vector components of the seller's move. At the extreme where one attribute has a weight ωⱼ approaching unity and all others approach zero, that attribute should have a relative compromise vector component weight approaching zero, or a relative consideration vector component weight approaching unity, as the case may be. Conversely, where an attribute has a weight ωⱼ approaching zero, that attribute should have a relative compromise vector component weight approaching unity, or a relative consideration vector component weight approaching zero, as the case may be.

From this analysis, specify a relative weight function r*(ω) for the compromise vector components that satisfies:

$${r}^{⋆} ( ω ) = \{ \begin{matrix}1 , & ω = 0 \\ 1 / N , & ω = 1 / N \\ 0 , & ω = 1\end{matrix}$$

Correspondingly, the relative weight function r′(ω) for the consideration vector components should satisfy:

$${r}^{′} ( ω ) = \{ \begin{matrix}1 , & ω = 0 \\ 1 / N , & ω = 1 / N \\ 0 , & ω = 1\end{matrix}$$

These functions may be specified most simply by fitting piecewise linear curves to the above waypoints for r*(ω) and r′(ω), yielding the following definitions:

$${r}^{*} ( ω ) = \{ \begin{matrix}- ( N - 1 ) ω + 1 , & 0 < ω \leq 1 / N \\ - \frac{1}{N - 1} ( ω - 1 ) , & 1 / N \leq ω < 1\end{matrix}$$

$${r}^{′} ( ω ) = ω , 0 < ω < 1$$

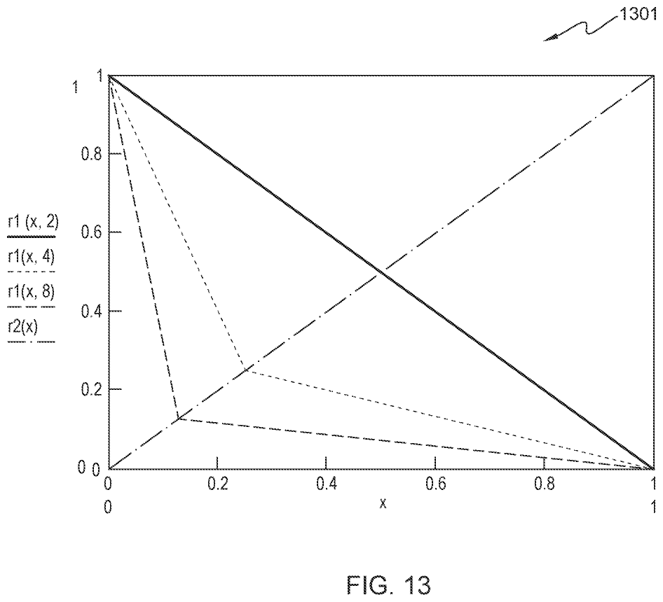

A plot of these curves is shown in FIG. 13. The curves 1301 labeled r1(x,2), r1(x,4) and r1(x,8) (with negative slopes) in this figure depict r*(ω) for N=2, 4, 8, respectively; the curve 1302 labeled r2(x) depicts r′(ω) for any N.

Thus the seller's step can be written as

$${y}_{i + 1} = {[ {g}_{1} {h}_{1} ( α , {ω}_{1} ) … {g}_{N} {h}_{N} ( α , {ω}_{N} ) ]}^{T} \qquad ( 3 )$$

where

$${g}_{j} = \{ \begin{matrix}1 , & \begin{matrix}j ∈ {I}_{A} , increase in seller ' s favor ; \\ or j ∈ {I}_{N} - {I}_{N C} , decrease in seller ' s favor\end{matrix} \\ - 1 , & \begin{matrix}j ∈ {I}_{N} - {I}_{N C} , increase in seller ' s favor ; \\ or j ∈ {I}_{A} , decrease in seller ' s favor\end{matrix} \\ 0 , & j ∈ {I}_{N C} , no change\end{matrix}$$

with

$${h}_{j} ( α , {ω}_{j} ) = \{ \begin{matrix}min [ \vert {d}_{ij}^{*} \vert , α {r}^{*} ( {ω}_{j} ) \vert {d}_{ij}^{*} \vert ] , & j ∈ {I}_{N} - {I}_{N C} \\ min [ \vert {b}_{ij} - {b}_{ij}^{*} \vert , α {r}^{′} ( {ω}_{j} ) \vert {b}_{ij} - {b}_{ij}^{*} \vert ] , & j ∈ {I}_{A}\end{matrix}$$

and α is a scalar step size attribute common to all dimensions.

A suggested move for the attributes already in agreement will not cause any of them to go out of agreement, although the user can of course alter the suggested move to produce this result.

Through the substitution of equation (3) into equation (1), the seller's new offer is specified to within the value of α, since all other components of equation (3) are known. The latter value is determined by the constraint invoked by the desired closure Dᵢ₊₁ in equation (2). From equation (2):

$$\vert {d}_{i + 1}^{*} \vert = ( 1 - {D}_{i + 1} ) \vert {d}_{i}^{*} \vert = \vert {b}_{i + 1}^{*} - {s}_{i + 1} \vert = \vert {b}_{i + 1}^{*} - ( {s}_{i} + {y}_{i + 1} ) \vert ,$$

where

$${b}_{i + 1}^{* ( j )} = \{ \begin{matrix}{b}_{i}^{( j )} , & j ∈ {I}_{N} ( i ) \\ {s}_{i}^{( j )} + {y}_{i + 1}^{( j )} , & j ∈ {I}_{A} ( i )\end{matrix}$$

A one-dimensional search over α determines the specification of the seller's move vector yᵢ₊₁. Depending on the set I_{NC}, it may not be possible to achieve an arbitrary degree of closure. If the seller is unwilling to compromise further on some subset of attributes, she obviously cannot achieve 100% closure, and in fact there will be some minimum possible closure, depending upon this set. Thus, in general the search over α is to find the minimum value of closure that does not exceed the specified value Dᵢ₊₁.

In the case where some or all of the attributes are discrete-valued, there will generally be no feasible value of yᵢ₊₁ for all possible values of d*ᵢ₊₁, since one cannot make continuous-valued steps in these attributes. However, we can calculate an appropriate and feasible value of yᵢ₊₁ using similar reasoning, as follows.

Let I_{DA} denote the index subset of I_{A} corresponding to discrete attributes in agreement, and similarly let I_{DN} denote the index subset of I_{N}−I_{NC} corresponding to discrete attributes not in agreement on which further compromise is allowable. Calculate the priority-scaled distances between the seller's current offer and the buyer's current bid, recognizing that for discrete-valued attributes, the absolute distances d*ᵢ can only take discrete values.

Rank the members of the set I_{DA} in descending order of priority (i.e., the highest priority ranked first) and the members of the set I_{DN} in ascending order of priority, so that I_{DA}(k) is the k^{th} highest priority discrete attribute of the set I_{DA}, while I_{DN}(k) is the k^{th} lowest priority discrete attribute of the set I_{DN}. Where ties in priority exist, the ranking among the attributes of a tied group is randomized within that group. Thus, for example, in the case where all discrete attributes are of equal priority, the entire sets of rankings would be randomized.

Now suppose that the seller elects to specify a closure on the (i+1)^{th} move of Dᵢ₊₁. First calculate the corresponding distance steps for the discrete attribute values and the resulting new offer vector, which generally will contain infeasible values of these attributes. Then selecting the first Dᵢ₊₁ % of the attributes in I_{DA} (i.e., the Dᵢ₊₁ % or less highest priority discrete attributes currently in agreement), and “round” the corresponding attribute values in the new offer to the nearest feasible attribute values in the seller's favor, with the remaining attribute values being rounded to the nearest feasible values in the buyer's favor. Similarly, selecting the first Dᵢ₊₁ % of the attributes in I_{DN} (i.e., the Dᵢ₊₁ % or less lowest priority discrete attributes currently in disagreement), and “round” the corresponding attribute values in the new offer to the nearest feasible attribute values in the buyer's favor, with the remaining attribute values being rounded to the nearest feasible values in the seller's favor.

The practical implications of this strategy for the set of discrete attributes are that, the larger the closure desired in the seller's next offer, the larger the fraction of highest priority attributes in the set I_{DA} on which consideration will be sought, and the larger the fraction of lowest priority attributes in the set I_{DN} on which compromise will be offered.

Let us expand the sets I_{DA} and I_{DN} to include non-ordered attributes, such as Boolean attributes or attributes such as color that have no natural ordering or distance measure. For non-ordered attributes in the set I_{DA}, no change will be suggested in the next offer. For non-ordered attributes in I_{DN}, compromise is offered on the Dᵢ₊₁ % or less lowest priority attributes by accepting the contra parties' values for these attributes, thus keeping the highest priority attributes in the seller's favor.

In the above analysis, the seller's one-sided priority for different attributes was the determinant of her negotiation strategy. However, it is straightforward to extend this strategy formulation to include both the seller's and buyer's priorities. Letting ωⱼ denote the seller's priority for the j^{th} attribute as before, and denoting the buyer's priority by ζⱼ, we can employ the following joint priority measure ωⱼ′:

$${ω}_{j}^{′} = {ω}_{j} ( 1 - \frac{{ζ}_{j}}{2} ) ,$$

When the seller's priority approaches zero, the joint priority approaches zero, regardless of the buyer's priority. When the seller's priority approaches unity, with the buyer's priority at zero, the joint priority approaches unity. When the seller's priority approaches unity, with the buyer's priority approaching unity as well, the joint priority approaches 0.5, which is tantamount to a “split the difference” strategy.

Described is the “algebra” of a negotiation method. A straightforward extension of this approach would be to implement an expert engine that controls this algebra in an automated fashion. The combination of these two would provide a complete negotiation bot.

In step 510 trading module receives the agreed upon negotiated transaction values and processes the sale of the commodity. In some embodiments, the completion of a transaction is stored in a blockchain or shared database to create a digital receipt of the transaction. This stored data may also be used to further improve the trading module 406 in both the pricing vs. quantity and value calculation for each of the options.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method for calculating the relationships between transaction values comprising:
extracting, by at least one processor, a set of user's preferences and priorities related to at least one asset;
scoring, by the at least one processor, at least one attribute, wherein the attribute is pertaining to the at least one asset;
generating, by the at least one processor, a graphical representation of the attributes of the at least one asset in a user interface, wherein a mutually acceptable transaction area is identified within at least two feasibility regions; and
processing, by the at least one processor, a transaction between a user and a contra party.

2. The computer-implemented method for calculating the relationships between transaction values of claim 1, wherein at least one extraction approach is used based on the numerical values of the attributes which the user has set in the user's preferences and priorities.

3. The computer-implemented method for calculating the relationships between transaction values of claim 1, wherein the scoring of the at least one attribute wherein a distribution of values is scored corresponding to the at least one attribute.

4. The computer-implemented method for calculating the relationships between transaction values of claim 1, wherein the scoring of the at least one attribute employs an analytic hierarchy process or similar ranking process.

5. The computer-implemented method for calculating the relationships between transaction values of claim 1, wherein the graphical representation of the attributes of the at least one asset has visual indicators of preferred relationship values.

6. The computer-implemented method for calculating the relationships between transaction values of claim 1, further comprising matching, by the one or more processors, the user with at least one contra party based on the at least one asset, and a set of limitations which the contra party has indicated.

7. The computer-implemented method of calculating the relationship between transaction values of claim 1, further comprising, aggregating, by the at least one processor, the set of user's preferences and a set of contra party preferences.

8. A computer-program for calculating the relationships between bids and offers, comprising:
one or more computer non-transitory readable storage media and program instructions stored on the one or more computer non-transitory readable storage media, the program instructions comprising:
program instructions to extract a set of user's preferences and priorities related to at least one asset;
program instructions to score at least one attribute, wherein the scoring of at least one attribute pertaining to the at least one asset employs an analytic hierarchy process or similar ranking process;
program instructions to generate a graphical representation of the attributes of the at least one asset in a user interface, wherein a mutually acceptable transaction area is identified between at least two feasibility regions, and the mutually acceptable transaction area is identified based on proximity to the user's preferences and priorities; and
program instructions to process a transaction between a user and a contra party(s).

9. The computer-program for calculating the relationships between bids and offers of claim 8, wherein at least one extraction approach is used based on the numerical values of the attributes which the user has set in the user's preferences and priorities.

10. The computer-program for calculating the relationships between bids and offers of claim 8, wherein the scoring of the at least one attribute wherein a distribution of values is scored corresponding to the at least one attribute.

11. The computer-program for calculating the relationships between bids and offers of claim 8, wherein the scoring of the at least one attribute employs an analytic hierarchy process or similar ranking process.

12. The computer-program for calculating the relationships between bids and offers of claim 8, wherein the graphical representation of the attributes of the at least one asset has visual indicators of preferred relationship values.

13. The computer-program for calculating the relationships between bids and offers of claim 8, further comprising program instructions to match the user with at least one contra party based on the at least one asset, and a set of limitations which the contra party has indicated.

14. The computer-program of calculating the relationship between bids and offers of claim 8, further comprising program instructions to aggregate the set of user's preferences and a set of contra party preferences.

15. A system for calculating the relationships between transaction values, comprising:
one or more computer non-transitory readable storage media and program instructions stored on the one or more computer non-transitory readable storage media, the program instructions comprising:
extract a set of user's preferences and priorities related to at least one asset;
score at least one attribute, wherein the attribute is pertaining to the at least one asset;
performing a stepwise negotiation process based on the user's preferences and priorities and a contra party's preferences and priorities;
generate a graphical representation of the attributes of the at least one asset in a user interface, wherein a mutually acceptable transaction area is identified within at least two feasibility regions; and
process a transaction between a user and contra party.

16. The system for calculating the relationships between transaction values of claim 15, wherein the scoring of the at least one attribute employs an analytic hierarchy process or similar ranking process.

17. The system for calculating the relationships between transaction values of claim 15, wherein the graphical representation of the attributes of the at least one asset has visual indicators of preferred relationship values.

18. The system for calculating the relationships between transaction values of claim 15, further comprising, program instructions to match the user with at least one contra party based on the at least one asset, and a set of limitations which the contra party has indicated.

19. The system of calculating the relationship between transaction values of claim 15, further comprising, program instructions to aggregate the set of user's preferences and a set of contra party preferences.
